(19) United States
(12) Patent Application Publication
(10) Pub. No.: US 2017/0269971 A1
(43) Pub. Date: Sep. 21, 2017

(54) MIGRATING ENTERPRISE WORKFLOWS FOR PROCESSING ON A CROWDSOURCING PLATFORM

(71) Applicant: International Business Machines Corporation, Armonk, NY (US)

(72) Inventors: Obinna B. Anya, San Jose, CA (US); Robert J. Moore, San Jose, CA (US); Hamid Reza Motahari Nezhad, San Jose, CA (US)

(21) Appl. No.: 15/071,098

(22) Filed: Mar. 15, 2016

(51) Int. Cl. G06F 9/50; G06F 17/30; G06F 17/24

(52) U.S. Cl. CPC G06F 9/5088; G06F 17/241; G06F 17/3053

(57) ABSTRACT

In one embodiment, a computer-implemented method includes: receiving a workflow, for each of the tasks in the workflow, annotating the task with a set of metadata, analyzing the tasks in the workflow utilizing the metadata annotations and one or more predefined policies, and based on the analysis of the tasks, generating an alternative configuration of the workflow. The workflow includes a plurality of tasks. The alternative configuration of the workflow is marked for crowdsourcing. In another embodiment, a computer program product for migrating a workflow for processing on a crowdsourcing platform includes a computer readable storage medium having program instructions embodied therewith. The program instructions are executable by a processor to cause the processor to cause the processor to perform the foregoing method.

### BACKGROUND

The present invention relates to utilizing a crowdsourcing platform to execute a workflow process, and more specifically, this invention relates to analyzing a workflow to evaluate its effectiveness for use in crowdsourcing.

Advances in computer technology, mobile communications, and the social web have expanded the sphere of potential work partners available to organizations, such as businesses, thereby expanding the available means of accomplishing work and developing innovative solutions to problems.

Current systems and practices in organizational crowdsourcing are manually executed. Further, these systems and practices do not provide adequate methods to enable the organization to determine what tasks to crowdsource, or to determine what workflow configuration most effectively supports (e.g., in terms of work quality, worker satisfaction, and secure use of organizational resources, etc.) the crowdsourced execution of the tasks. Moreover, these systems and practices do not sufficiently enable the organization to address concerns of security and privacy with respect to organizational resources that may be required to perform tasks on a crowdsourcing platform. Still yet, these systems and practices do not provide sufficient support for recommending tasks and transforming workflows to a form that is appropriate for the crowdsourcing platform.

Other methods of crowdsourcing complex tasks of organizational workflows often resort to breaking the tasks down into a set of smaller tasks, commonly known as micro-tasks, which are then sent out to crowdworkers. They require that managers engage in lengthy and in advance planning efforts that do not scale and lead to high costs.

Accordingly, current crowdsourcing systems fail to enable managers to determine what tasks are most amenable to crowdsourcing. Such systems also fail to enable the managers to effectively manage the crowdsourcing process in a way that safeguards organizational assets, or guarantees an acceptable quality of crowdsourced work.

### SUMMARY

In one embodiment, a computer-implemented method includes: receiving a workflow, for each of the tasks in the workflow, annotating the task with a set of metadata, analyzing the tasks in the workflow utilizing the metadata annotations and one or more predefined policies, and based on the analysis of the tasks, generating an alternative configuration of the workflow. The workflow includes a plurality of tasks. The alternative configuration of the workflow is marked for crowdsourcing.

In another embodiment, a computer program product for migrating a workflow for processing on a crowdsourcing platform includes a computer readable storage medium having program instructions embodied therewith. The program instructions are executable by a processor to cause the processor to cause the processor to perform the foregoing method.

In yet another embodiment, a system includes: a processor and logic integrated with and/or executable by the processor. The logic is configured to: receive a workflow, for each of the tasks in the workflow, annotate the task with a set of metadata, analyze the tasks in the workflow utilizing the metadata annotations and one or more predefined policies including generating a crowdsourceability score for each task in the workflow, and based on the analysis of the tasks and the crowdsourceability scores, generate an alternative configuration of the workflow. The workflow including a plurality of tasks. The alternative configuration of the workflow is marked for crowdsourcing.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 illustrates a method for migrating a workflow for processing on a crowdsourcing platform, in accordance with one embodiment.

FIG. 4 illustrates a system for migrating workflows for processing on a crowdsourcing platform, in accordance with one embodiment.

FIG. 5 illustrates a system for migrating workflows for processing on a crowdsourcing platform, in accordance with one embodiment.

FIG. 6 illustrates a workflow, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for migrating workflows for processing on a crowdsourcing platform.

In one general embodiment, a computer-implemented method includes: receiving a workflow, for each of the tasks in the workflow, annotating the task with a set of metadata, analyzing the tasks in the workflow utilizing the metadata annotations and one or more predefined policies, and based on the analysis of the tasks, generating an alternative configuration of the workflow. The workflow includes a plurality of tasks. The alternative configuration of the workflow is marked for crowdsourcing.

In another general embodiment, a computer program product for migrating a workflow for processing on a crowdsourcing platform includes a computer readable storage medium having program instructions embodied therewith. The program instructions are executable by a processor to cause the processor to cause the processor to perform the foregoing method.

In yet another general embodiment, a system includes: a processor and logic integrated with and/or executable by the processor. The logic is configured to: receive a workflow, for each of the tasks in the workflow, annotate the task with a set of metadata, analyze the tasks in the workflow utilizing the metadata annotations and one or more predefined policies including generating a crowdsourceability score for each task in the workflow, and based on the analysis of the tasks and the crowdsourceability scores, generate an alternative configuration of the workflow. The workflow including a plurality of tasks. The alternative configuration of the workflow is marked for crowdsourcing.

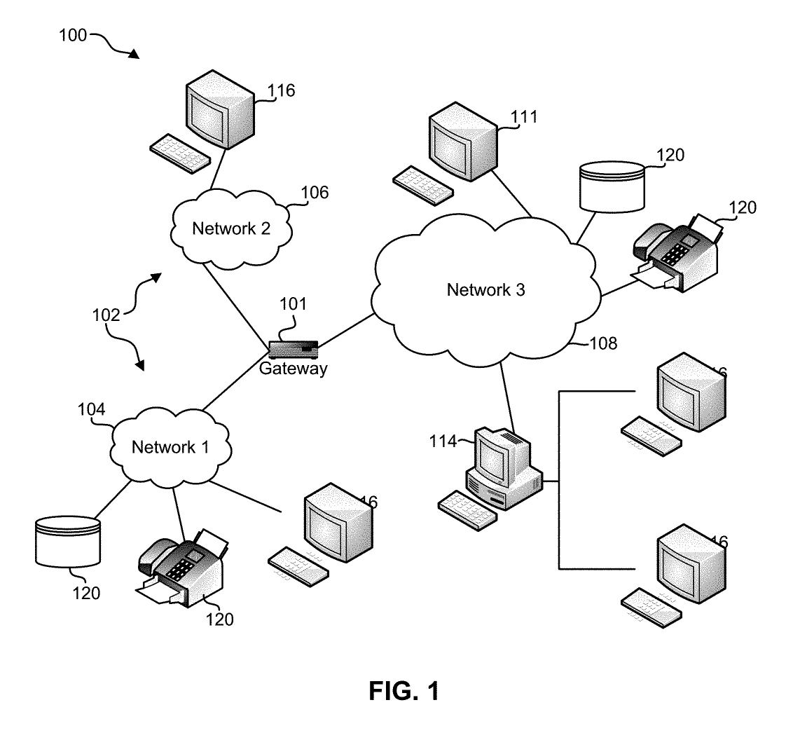

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

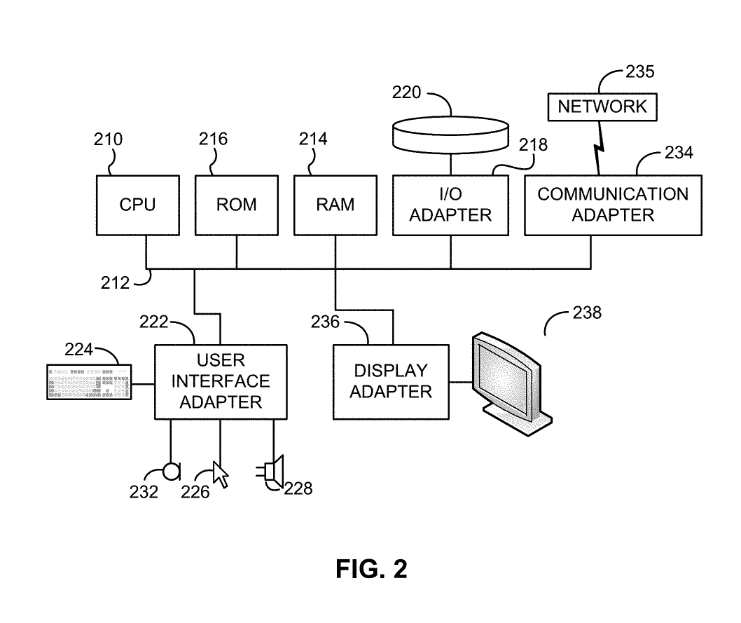

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a MAC OS, a UNIX OS, etc. It will be appreciated that a preferred embodiment may also be implemented on platforms and operating systems other than those mentioned. A preferred embodiment may be written using XML, C, and/or C++ language, or other programming languages, along with an object oriented programming methodology. Object oriented programming (OOP), which has become increasingly used to develop complex applications, may be used.

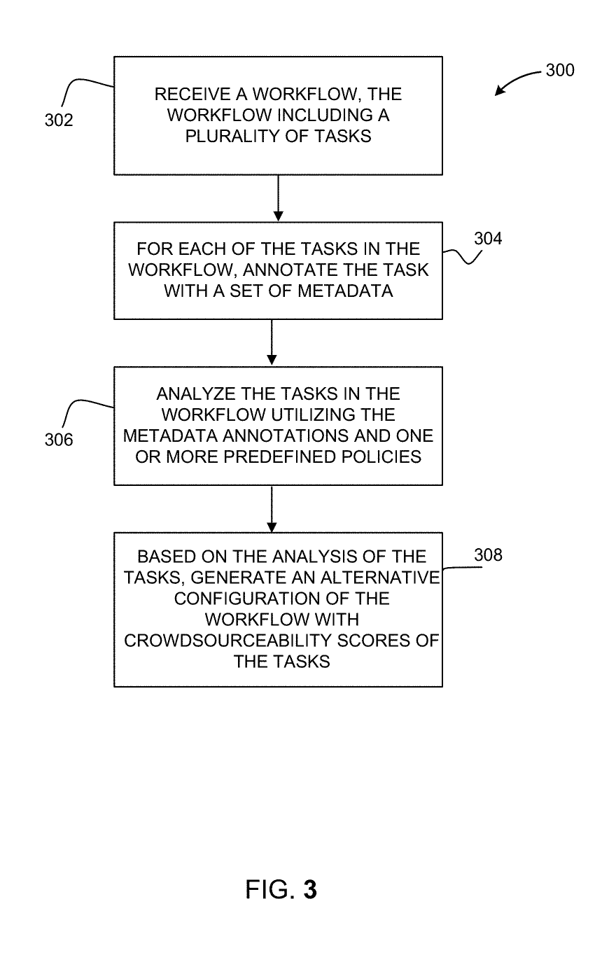

Now referring to FIG. 3, a flowchart of a method 300 is shown according to one embodiment. The method 300 may be performed in accordance with the present invention in any of the environments depicted in FIGS. 1-2, among others, in various embodiments. Of course, more or less operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a processor, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3, method 300, for migrating a workflow for processing on a crowdsourcing platform, may initiate with operation 302, where a workflow is received. The workflow includes a plurality of tasks. As used herein a workflow comprises an organized series or sequence of tasks through which work passes in order for the work to be completed. Also, the workflow may include various process model constructs, such as fork, join, sequence, concurrency, choice, and synchronization.

As an option, the workflow may comprise a business workflow. A business workflow may comprise any workflow performed by an organization during the course of business. For example, a business workflow may comprise a workflow that furthers one or more business objectives, such as, for example, customer service, sales, data verification, system maintenance, etc. Accordingly, a workflow may be designed to reflect the structure(s) and function(s) of an organization. For example, the workflow may indicate that certain tasks are to be performed by people with certain roles, or that certain tasks require the use of specific organizational resources.

Each of the tasks in the workflow comprises a portion of labor for progressing the workflow to completion. Each task has a discrete beginning and discrete conclusion that enables the task to be identified as separate from other tasks in the workflow, such as preceding or subsequent tasks in the workflow. As an option, one or more of the tasks within a workflow may be dependent upon each other. In other words, work on one or more given tasks may need to be completed before work on one or more other tasks may be started. Also, executing any of the tasks may require the use of one or more resources of an organization. In one embodiment, execution of a task may be based on a finite state machine with states such as: available, suspended, crowdsourced processing, in-house processing, and/or completed.

As used herein, a crowdsourced task comprises a task carried out or completed, either partially or entirely, by one or more crowdworkers. A crowdworker is a person who is not a conventional employee of, supplier for, or direct contractor for the organization for which the task is being completed. Crowdsourcing tasks of a workflow may improve automation of the workflow and related business processes.

A crowdsourced task may be a task of limited complexity, or a task for which a large number of answers are required in a short period of time (e.g., tagging a picture, translating a piece of text, testing a piece of software, designing a logo, refactoring software code, ideation and problem brainstorming, reversing engineering of software code, etc.). Other exemplary tasks of a workflow that may be ideal for crowdsourcing include: validating online user input through CAPTCHA, answering one or more questions which a computer is generally incapable of performing or is inefficient at performing, or performing other tasks which are more suitable for a human or humans to complete. These tasks may be otherwise referred to as human intelligence tasks (HITs). Some HITs may be suitable for completion by a human workforce rather than, for example, a single-subject matter expert.

Moreover, a crowdsource platform registers users that would like to receive work from the platform, and assigns work (i.e., tasks) to the users for completion. The crowdsource platform may also track its users with regard to work performed by the users (e.g., work assigned, quality of work completed, timeliness of work completed, etc.).

Additionally, at operation 304, each of the tasks in the workflow is annotated with a respective set of metadata. In particular, each task in the workflow is annotated with a set of metadata corresponding to characteristics of the task. As used herein, a set of metadata that annotates a task includes any information that describes the task, or may be used to determine the crowdsourceability of the task. For example, the metadata may include properties, requirements, or constraints of a task. Accordingly, annotating a task with a set of metadata comprises the process of creating or modifying metadata that is associated with the task.

In one embodiment, annotating a task includes generating an annotation that includes at least one input annotation and/or at least one output annotation. As an option, the at least one input annotation of the task includes one or more policy constraints of the task, one or more temporal constraints of the task, one or more structural constraints of the task, and/or one or more resource requirements of the task. Moreover, each input annotation of the task may be associated with a value.

For example, a workflow, X, may include a set of tasks: {x₁, x₂, . . . , xₙ}, representing a unit of work to be performed. This representation of the workflow, X, may be used to determine a crowdsourceability of the workflow. In particular this representation may be utilized to determine a configuration of X, or a configuration of a part of X, that reduces the cost of performing X, improves the work quality output from the performance of X, and/or safeguards organizational assets.

In one embodiment, a workflow model representing X may be defined as a directed graph G=(X, E), where a node xεX is exactly one of the following: a task, a start node, a stop node, a fork, a join point, a decision point, or synchronization point in X. Each eεE represents a control flow of the workflow. In this workflow model, a task may be annotated with metadata. The metadata may be defined through properties of the task. The metadata may describe policy constraints, temporal constraints, structural constraints, resource requirements, etc. Accordingly, for each task xεX, there may be one or more inputs in (x)=[input₁(x), input₂(x), . . . , inputₙ(x)] denoting the task properties as well as policy constraints, temporal constraints, structural constraints, resource requirements, etc. for performing x. Also, each task may generate one or more outputs [output₁(x), output₂(x), outputₙ(x)] denoting the results of performing x.

During execution of the method 300, the set of properties, constraints, and resource requirements for executing each task in the workflow may be identified. Each inputᵢ may be associated with a weighting value representing the computed effect of using the sets of properties, constraints, and resource requirements to perform the task. Table 1 provides an exemplary set of factors (e.g., properties, constraints, and resource requirements) that may be used as part of a decision making function for determining the crowdsourceability of a task. Of course, other factors not presented in Table 1 may be used. The factors of Table 1 are intended to be for illustrative purposes only, and should not be construed as limiting in any manner.

TABLE 1

| Factor | Value |
|---|---|
| Data privacy | Boolean (0, 1) |
| Benefit from scalability | Range (0 . . . 1) |
| Workload (volume of transaction) | Range (0 . . . 1) |
| Composability | Range (0 . . . 1) |
| Matching_expertise_can_be_found | Range (0 . . . 1) |
| Type of task (onsite, remote, etc.) | Range (0 . . . 1) |
| Crowd_vs_inhouse_cost_proportion | Range (0 . . . 1) |
| Time estimate via crowd | Range (0 . . . 1) |
| Quality estimate via crowd | Range (0 . . . 1) |

A decision making function may comprise an objective function that minimizes, or maximizes, a given factor. For example, the decision making function may minimize or maximize cost, quality, or time for completion. Further, a given path from a start node to an end node of the workflow X represents a given configuration for performing X.

The annotation of a task may include, attributing a value to each of the factors. The value may include a Boolean value (0 or 1), or a real number with a range between 0 and 1. As an option, when the value attributed to a factor is closer to 1, the value may indicate that, with respect to that factor, the task benefits more from crowdsourcing than when if value attributed to the factor is closer to 0. For example, with respect to an annotation of a task that indicates a quality estimate for completion of the task via crowdsourcing, a value of 0.8 may indicate that the task benefits more from crowdsourcing than if a value of 0.3 was attributed to the factor.

In one embodiment, one or more of the factors may be utilized as filters. These filters may be utilized to determine hard constraints on the crowdsourceability of a task. These constraints may be imposed due to, for example, reasons of data confidentiality and privacy. For example, a Boolean value attributed to a data privacy factor may be used as such a filter. In particular, when the data privacy factor of a task is attributed a Boolean value of 1, then the task may be precluded from crowdsourcing. Another factor that may be utilized as a filter may include a factor that indicates whether or not a human can perform the task, or whether the task can be completed by a computer system.

In one embodiment, the annotation of a task may be performed manually (e.g., by a user, etc.) or automatically. For example, one or more of the factors may be computed utilizing external functions, or one or more of the factors may be input via an input device (e.g., keyboard, mouse, smartphone, etc.), such as, for example, by a user (e.g., a human operator, etc.).

In one embodiment, the annotation of a task may include a factor that indicates whether the task benefits from scalability (i.e., “Benefit from scalability”). For example, a value associated with the factor may indicate how much the task benefits from being completed by workers of a crowd in comparison to being completed by a single entity, such as a single person or computer. For some tasks, employing more than one person to complete the task improves the quality with which the task is completed. Such tasks may be easier for a human to perform than configuring a machine to perform. Accordingly, these tasks may benefit from having more than one person perform the tasks. A factor that indicates whether a task benefits from scalability may be attributed a value with a range between 0 and 1, and the closer the value is to 1, then the greater the task benefits from scalability.

In one embodiment, a dictionary of tasks may be constructed. For each of the tasks in the dictionary, the dictionary may identify a frequency (e.g., a relative frequency, etc.) with which the task is crowdsourced (e.g., provided to a crowdsourcing platform). The frequencies tracked in the dictionary may be utilized to find the types of tasks that benefit from crowdsourcing and/or scale contributions. Additionally, for each of the tasks in the dictionary, the dictionary may track one or more keywords related to the task. The keywords may be generated by and/or received from one of the crowdsourcing platforms. Thereafter, for a given task in a workflow, the given task may be matched to one or more tasks in the dictionary based on keywords. For each match identified between the given task and the one or more matching tasks in the dictionary, a matching score may be calculated. Further, utilizing the matching scores, and the frequencies attached to the matching tasks, a value may be determined for the factor that indicates whether the given task benefits from scalability.

In one embodiment, the annotation of a task may include a factor that indicates a volume or workload of the task (i.e., “Workload (volume of transaction)”). For example, a value associated with the factor may indicate the number of times that the task is performed within a defined period. For example, the value associated with the factor may indicate the number of times that the task is performed within a given workflow, within a given process, within a given process instance, within a given session, or within a given day, etc. The value attributed to the factor may be depend on whether the crowdsourceability of the task increases or decreases with an increase in frequency of task performance.

In one embodiment, the annotation of a task may include a factor that indicates a composability of the task (i.e., “Composability”). For example, a value associated with the factor may indicate whether the task can be, and to what degree, decomposed into smaller independent micro-tasks that can be allocated to workers of a crowd, or if the task requires repetition by workers of a crowd. A factor that indicates the composability of a task may be attributed a value with a range between 0 and 1, and the closer the value is to 1, then the greater the task benefits from being crowdsourced.

In one embodiment, the annotation of a task may include a factor that indicates whether expertise matching the task can be found (i.e., “Matching_expertise_can_be_found”). For example, a value associated with the factor may indicate whether the likelihood that a given crowd of workers utilized for crowdsourcing will include the expertise required to complete the task in a satisfactory manner. As an option, the analysis of a task including this factor may include first identifying approved crowdsourcing platforms, and then identifying members of the approved platforms with the requisite expertise to complete the task. A factor that indicates the required expertise of a task may be attributed a value with a range between 0 and 1, and the value may identify the average level of expertise of the top matching members of the approved crowdsourcing platforms.

In one embodiment, the annotation of a task may include a factor that indicates a type of the task (i.e., “Type of task (onsite, remote, etc.)”). The type of the task may reflect whether the task can be completed outside of the office environment of the business for which the workflow is being completed, and/or the efficiency with which the task can be completed outside of the office environment of the business. For example, a workflow may include some tasks that are required to be completed at the office environment of the business, and accordingly cannot be crowdsourced. As another example, some tasks may be performed more effectively within the office environment of the business, because of, for example, access to physical or technological resources. A factor that indicates the type of a task may be attributed a value with a range between 0 and 1, and the closer the value is to 1, then the more the task is suited for completion remotely and by workers of a crowd.

In one embodiment, the annotation of a task may include a factor that indicates a proportional cost (i.e., “Crowd_vs_inhouse_cost_proportion”). This factor may reflect a cost of performing the task at the office environment of the business for which the workflow is being completed in comparison with a cost of performing the task utilizing workers of a crowd. In other words, this factor reflects a proportional cost of performing the task at the office environment of the business for which the workflow is being completed versus an estimated cost of crowdsourcing the task. As an option, the crowdsourcing cost estimate may be determined based on an average cost of work completed by matching workers of a crowd on one or more selected crowdsourcing platforms. A factor that indicates the proportional cost of a task may be attributed a value with a range between 0 and 1, and the closer the value is to 1, the greater the cost benefit of having the task completed by workers of a crowd.

In one embodiment, the annotation of a task may include a factor that indicates a time estimate for completion of the task by workers of a crowd (i.e., “Time estimate via crowd”). This factor may reflect an estimate of the time needed to complete the task using crowdsourcing. The estimate of the time needed to complete the task using crowdsourcing may take into account the sum of all sequential subtasks that need to be performed by workers of a crowd to complete the task. Moreover, the estimate of the time needed to complete the task using crowdsourcing may take into account an additional percentage of time for the coordination needed to gather and compile a final result of the work. As an option, a value for this factor may be an average of time estimates for one or more selected crowdsourcing platforms.

In one embodiment, the annotation of a task may include a factor that indicates a quality estimate for completion of the task by workers of a crowd (i.e., “Quality estimate via crowd”). This factor may reflect an estimate of the quality of the work completed for the task when the task is completed by workers of a crowd. The estimate of the quality of the work completed by members of the crowd may be computed by identifying approved crowdsourcing platforms, and then identifying assessments of workers of the platforms. For example, an average review or rating (e.g., scale from 1 to 5, scale from 1 to 10, scale out of 100, etc.) of a top X % of the workers of the platforms may be utilized to estimate the quality of the work that will be performed for the task. A factor that indicates the quality estimate for completion of the task by workers of a crowd may be attributed a value with a range between 0 and 1, and the closer the value is to 1, the greater the expectation is of the quality of work completed by workers of a crowd.

Referring again to FIG. 3, at operation 306, the tasks in the workflow are analyzed utilizing the metadata annotations and one or more predefined policies. In one embodiment, the one or more predefined policies include one or more rules for determining the crowdsourceability of a task. In other words, for a given task in the workflow, the metadata annotations of the task and one or more policies are evaluated to determine whether the task should be crowdsourced, or if the task should be not be crowdsourced (i.e., the task should be completed within the office environment of the business for which the workflow is being completed, etc.). Accordingly, analyzing a task in a workflow may include comparing the values of annotations of the task with one or more threshold values defined by the policies. Still yet, analyzing a task in a workflow may include computing a value (e.g., a mean, a weighted average, etc.) utilizing the one or more values of annotations of the task, and comparing the computed value to a threshold. For example, the overall crowdsourceability factor of a task may be computed as a geometric mean of the weighted product of the values of each of the factors described above.

In one embodiment, the analysis of a task includes evaluating an overall utility function that computes the overall crowdsourceability factor, or crowdsourceability score, of the task, preferably for each task in the workflow. In one specific embodiment, the crowdsourceability score for a task may be computed as 2N\sqrt{Π₁^{N}wᵢfᵢ}, where wᵢ is the weight of factor fᵢ, fᵢ denotes the value for factor fᵢ, and N denotes the number of factors. By allowing a unique weight for each of the factors, a user may control the importance of various factors in the final crowdsourceability score. As an option, the weights may be set to values between 0 and 1, where a higher value indicates a higher importance for the factor. Examples of importance factors include cost, time, or quality factors, where an organization may put more emphasis on one or more of these factors. It should be noted that the weights may be configured differently for different tasks.

The interpretation of the crowdsourceability score for a task may be context dependent, and/or enterprise specific. For example, one department of an enterprise may determine that a given crowdsourceability score of a task requires that the task be completed in-house, while another department of the enterprise may allow the crowdsourcing of tasks scored with the same crowdsourceability score. In one embodiment, a threshold may be configured, and whenever a task is computed as having a crowdsourceability score above the threshold, the task is considered a crowdsourcing candidate.

In one embodiment, the analysis of the tasks in the workflow includes natural language processing. For example, the analysis of a task may include identifying, via natural language processing, terms or phrases that are associated with a task that indicate the task is associated with sensitive subject matter, thereby precluding its crowdsourcing. The terms and phrases associated with the task may include a task label, metadata information, etc. The information rendered by the natural language processing may be used to generate or affect crowdsourceability scores for the tasks in the workflow.

In one embodiment, the analysis of the tasks in the workflow includes calculating conceptual similarity metrics. For example, the analysis of a task may include determining whether the task is similar to other tasks that have been previously completed by workers of a crowdsourcing platform or by in-house employees. As an option, any conceptual similarity metrics computed for a task may be utilized to adjust the crowdsourceability score of the task. The conceptual similarity metrics computed for a task may be computed using a label of the task, metadata information of the task, etc. The conceptual similarity metrics may be used to generate or affect crowdsourceability scores for the tasks in the workflow.

Still further, the analysis of the tasks in the workflow may include accounting for dependencies that exist between two or more tasks, as well as task-resource associations, and task-person associations. In this way, the analysis of the tasks of a workflow for determining whether one or more of the tasks may be crowdsourced accounts for relationships between the tasks, resources, and persons available for performing the tasks. Moreover, these metrics may be used to generate or affect crowdsourceability scores for the tasks in the workflow.

Also, at operation 308, an alternative configuration of the workflow is generated based on the analysis of the tasks. The alternative configuration of the workflow is marked for crowdsourcing. Preferably, the alternative configuration of the workflow is generated with and/or based on the crowdsourceability scores of the tasks. As used herein, generating an alternative workflow comprises any operation that results in a workflow different than the workflow received at operation 302.

In one embodiment, the alternative configuration of the workflow includes at least one of the tasks in the received workflow that have been selected for sharing with a crowdsourcing platform. The analysis of the tasks at operation 306 may identify one or more tasks in the workflow that are suitable for crowdsourcing. The one or more tasks in the workflow suitable for crowdsourcing may have, for example, been computed to have a crowdsourceability score in excess of a threshold. The alternative configuration of the workflow may better enable the crowdsourcing of the tasks that have been identified as suitable for crowdsourcing. In other words, the alternative configuration of the workflow comprises a configuration of the workflow that is better suited for the crowdsourcing of one or more tasks within the workflow. As an option, the alternative configuration of the workflow includes all of the tasks in the received workflow that have been selected for sharing with the crowdsourcing platform.

In one embodiment, the alternative configuration of the workflow may comprise a hybrid model of the received workflow, wherein tasks that will be completed in-house are logically separated from the tasks that are selected for sharing with a crowdsourcing platform. By logically separating the tasks to be completed in-house from the tasks that are selected for sharing with the crowdsourcing platform, sensitive organizational assets may be safeguarded from unauthorized access by members of the crowdsourcing platform. Further, by logically separating the tasks to be completed in-house from the tasks that are selected for sharing with the crowdsourcing platform, overall work quality may be increased while reducing costs.

In one embodiment, the alternative configuration of the workflow is a new workflow that may be transmitted to a crowdsourcing platform for crowdsourcing of the tasks therein. The new crowdsourceable workflow may be assembled in a manner that safeguards organizational assets, is completed at a reduced cost, and/or improves the quality of the work performed. Accordingly, the alternative configuration of the workflow, or a portion thereof, may be forwarded to a crowdsourcing platform. At that point, the crowdsourcing platform may assign the tasks for various members or workers of the platform so that the tasks can be completed.

In the manner set forth above, for a given workflow containing a plurality of tasks, an alternative workflow may be generated that enables an organizational employee to determine which tasks of the workflow may be efficiently crowdsourced. Also, the workflow may be managed in a way that safeguards the organization's intellectual property and leads to high quality of work. In other words, the systems and methods disclosed herein enable automatic reconfiguration of existing workflows at runtime to support flexible assignment of tasks to workers of a crowd, and ensure the correctness of the process design, data flow, and time constraints in a way that safeguards organizational assets, and leads to improved work quality and reduced cost. Accordingly, a legacy workflow that was not originally designed for crowdsourcing may be tweaked for execution on a crowdsourcing platform, thereby improving overall organizational productivity.

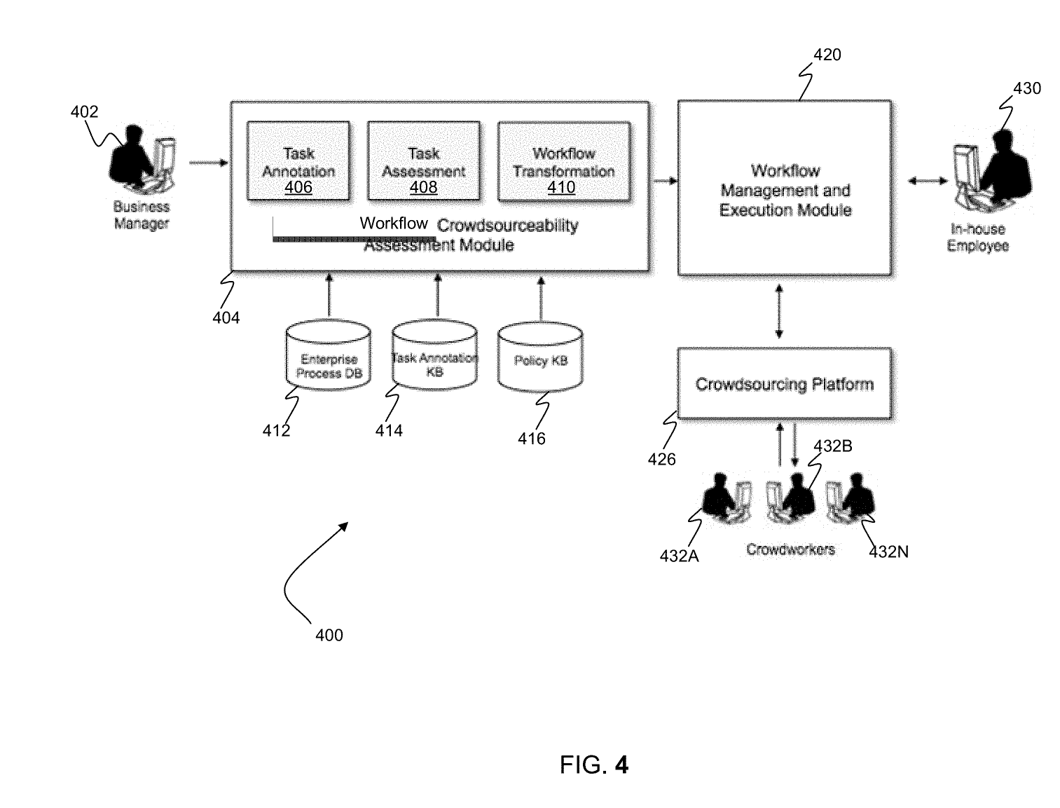

FIG. 4 depicts a system 400 for migrating workflows for processing on a crowdsourcing platform, in accordance with one embodiment. As an option, the present system 400 may be implemented in conjunction with features from any other embodiment listed herein, such as those described with reference to the other FIGS. Of course, however, such system 400 and others presented herein may be used in various applications and/or in permutations which may or may not be specifically described in the illustrative embodiments listed herein. Further, the system 400 presented herein may be used in any desired environment.

The system 400 is shown to include a workflow crowdsourceability assessment module 404, a workflow management and execution module 420, an enterprise process database 412, a task annotation knowledge base 414, a policy knowledge base 416, and a crowdsourcing platform 426.

As shown in FIG. 4, a business manager 402 identifies a workflow for processing by the workflow crowdsourceability assessment module 404. In one embodiment, the business manager is an employee of an organization. Further, the workflow may comprise a business workflow that furthers a business interest of the organization. For example, the workflow may include the process of maintaining legacy application software. In such an example, the business manager 402 may be an employee of a company that developed the legacy application, or an employee of a company that still utilizes the legacy application during business operations.

In such an example, there may be numerous considerations that weigh on whether portions of this workflow can be crowdsourced to individuals outside of the organization. For example, the tasks required to maintain the legacy application may include changing code, testing code, etc. Determining whether these tasks can be crowdsourced or should be performed in-house may include considering the degree of damage associated with releasing the code outside of the organization, the level of expertise required to work on the legacy application; the maximum amount of time to be allowed to maintain the legacy application; what part(s) of the legacy application (logical or physical) require fixing; and/or the level of access required by a worker to fix the legacy application.

Upon receiving an identification of the workflow selected by the business manager 402, the workflow is processed by the workflow crowdsourceability assessment module 404. In particular, a task annotation component 406 annotates each of the tasks in the workflow with a respective set of metadata, as described in the context of operation 304 of FIG. 3. Moreover, a task assessment component 408 analyzes the tasks in the workflow utilizing the metadata annotations and one or more predefined policies, as described in the context of operation 306 of FIG. 3. Still further, a workflow transformation component 410 generates an alternative configuration of the workflow based on the analysis of the tasks, as described in the context of operation 308 of FIG. 3.

The operations of the task annotation component 406, the task assessment component 408, and the workflow transformation component 410 are informed by the enterprise process database 412, the task annotation knowledge base 414, and the policy knowledge base 416. Specifically, the workflow crowdsourceability assessment module 404 may retrieve the workflow from the enterprise process database 412 after the business manager 402 identifies/selects the workflow for processing.

Further, the task annotation knowledge base 414 may be utilized for annotating the tasks of the selected workflow. In particular, prior annotations of the tasks in the particular workflow may be retrieved from the task annotation knowledge base 414. As an option, other tasks of other workflows in the enterprise process database 412 may be identified as being similar to the tasks of the selected workflow. Accordingly, the annotations of these similar tasks may be retrieved from the task annotation knowledge base 414 for informing the annotations of the tasks of the workflow selected by the business manager 402.

Also, the policy knowledge base 416 may store one or more policies utilized for determining the crowdsourceability of the tasks in the workflow.

After the workflow crowdsourceability assessment module 404 has processed the workflow selected by the business manager 402, the workflow crowdsourceability assessment module 404 outputs an alternative configuration of the workflow to the workflow management and execution module 420. Upon receiving the alternative configuration of the workflow, the workflow management and execution module 420 identifies the tasks in the alternative configuration of the workflow that have been selected for sharing with a crowdsourcing platform, and provides the selected tasks to the crowdsourcing platform 426. Moreover, upon receiving the alternative configuration of the workflow, the workflow management and execution module 420 assigns to an in-house employee 430 any tasks that have not been selected for sharing with the crowdsourcing platform 426. The in-house employee 430 and the business manager 402 may be employed by the same organization.

In this way, the alternative configuration of the workflow may comprise a hybrid workflow that is logically divided in a manner that allows for the efficient assignment of respective tasks to both the in-house employee 430 and crowdworkers 432A, 432B . . . 432N.

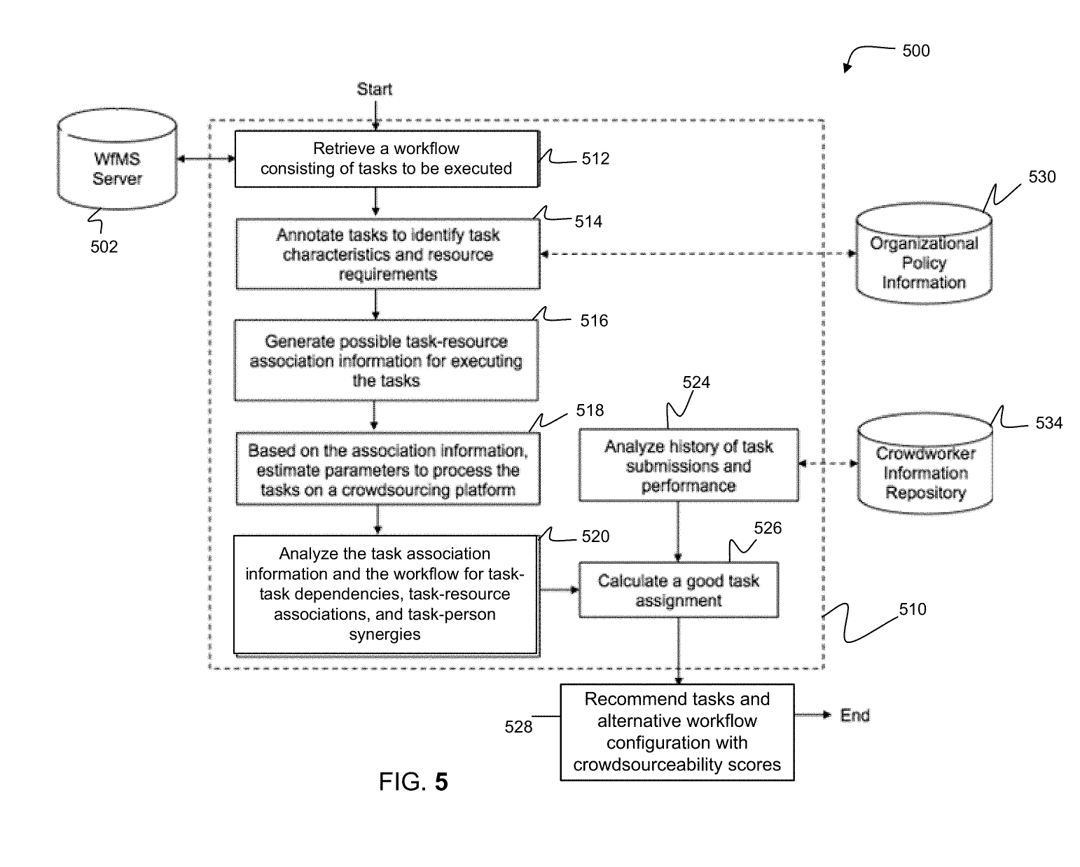

FIG. 5 depicts a system 500 for migrating workflows for processing on a crowdsourcing platform, in accordance with one embodiment. As an option, the present system 500 may be implemented in conjunction with features from any other embodiment listed herein, such as those described with reference to the other FIGS. Of course, however, such system 500 and others presented herein may be used in various applications and/or in permutations which may or may not be specifically described in the illustrative embodiments listed herein. Further, the system 500 presented herein may be used in any desired environment.

As illustrated in FIG. 5, the system 500 is shown to include a workflow management system server 502, a workflow crowdsourceability assessment module 510, an organizational policy information database 530, and a crowdworker information repository 534.

The workflow management system server 502 is in communication with the workflow crowdsourceability assessment module 510 such that the workflow crowdsourceability assessment module 510 receives workflows from the workflow management system server 502. In particular, FIG. 5 illustrates, at operation 512, the workflow crowdsourceability assessment module 510 retrieving a workflow from the workflow management system server 502. The retrieved workflow includes tasks to be performed.

Also, at operation 514, the tasks are annotated by the workflow crowdsourceability assessment module 510. Each of the tasks in the workflow may be annotated with a respective set of metadata, as described in the context of operation 304 of FIG. 3. The annotation of the tasks at operation 514 is informed by organizational policy information retrieved from the organizational policy information database 530. For example, some tasks may be annotated with a sensitivity or confidentiality value that is informed by organizational policies, some tasks may be annotated with a benefit from scalability value that is informed by organizational policies, and/or some tasks may be annotated with a proportional cost value that is informed by organizational policies. The annotation of the tasks identifies characteristics and resource requirements of the tasks.

At operation 516, the workflow crowdsourceability assessment module 510 generates possible task-resource association information for executing the tasks, and, at operation 518, estimates, based on the association information, parameters to process the tasks on a crowdsourcing platform.

Moreover, at operation 520, the workflow crowdsourceability assessment module 510 analyzes the task association information and the workflow to identify any task-task dependencies, task-resource associations, and task-person synergies. Based on this analysis, a good task assignment is calculated at operation 526. The calculation of the good task assignment is informed by a prior analysis, performed at operation 524, of historical task submissions, and the performances thereof. In particular, at operation 524, information retrieved from the crowdworker information repository 534 is utilized to determine the historical outcome of previously crowdsourced tasks (e.g., quality, timeliness, accuracy, etc.). Accordingly, the calculated task assignment of operation 526 is informed by historical information relating to the completion of, and quality of, work previously completed by crowdworkers.

Finally, based on the calculated task assignments, a workflow configuration that includes task assignments is recommended at operation 528. In one embodiment, as shown in operation 528, the recommended task and workflow configuration comprises an alternative configuration of the workflow retrieved at operation 512, as described above in the context of FIG. 3. Moreover, the alternative workflow configuration preferably includes crowdsourceability scores. Further, based on the recommended task and workflow configuration, tasks of the workflow may be provided to a crowdsourcing platform for subsequent performance by the crowdworkers of the crowdsourcing platform.

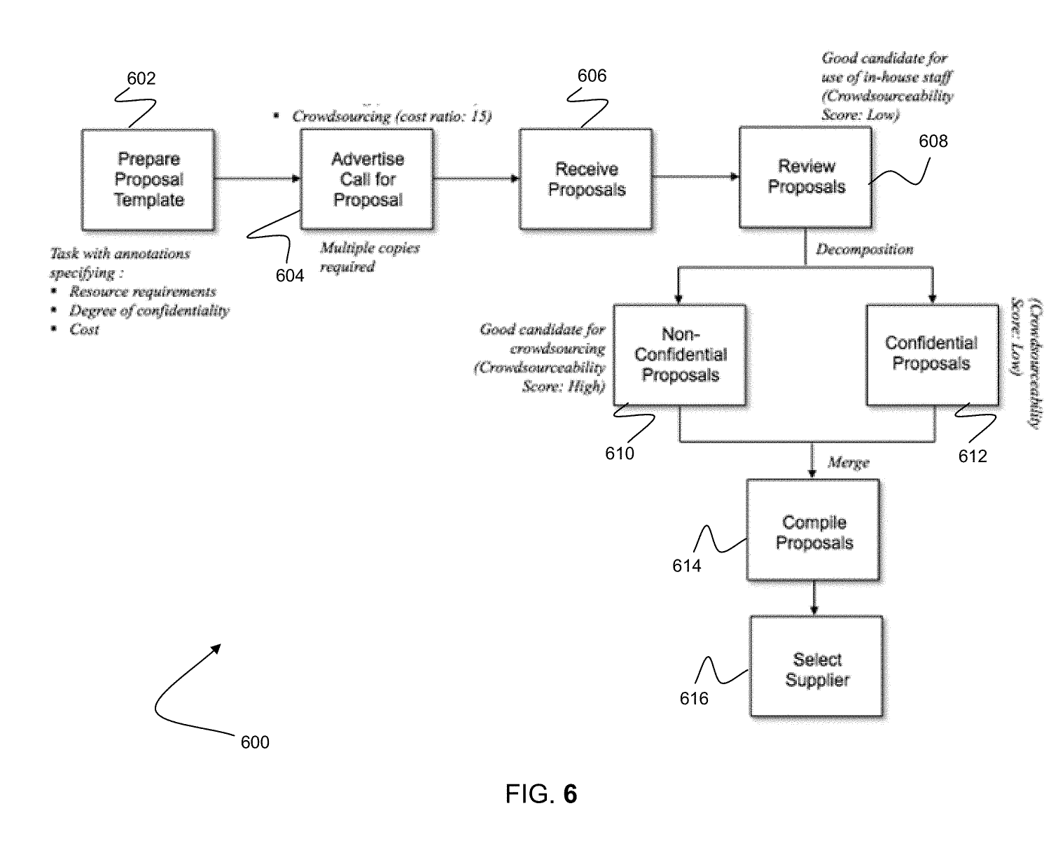

FIG. 6 depicts a workflow 600, in accordance with one embodiment. As an option, the present workflow 600 may be implemented in conjunction with features from any other embodiment listed herein, such as those described with reference to the other FIGS. Of course, however, such workflow 600 and others presented herein may be used in various applications and/or in permutations which may or may not be specifically described in the illustrative embodiments listed herein. Further, the annotated workflow 600 presented herein may be used in any desired environment.

As illustrated by FIG. 6, the workflow 600 includes a plurality of tasks 602-616. In particular, the workflow 600 includes a prepare proposal template task 602, an advertise call for proposal task 604, a receive proposals task 606, a review proposals task 608, a compile proposals task 614, and a select supplier task 616. The review proposals task 608 is shown decomposed into two tasks: a review non-confidential proposals task 610 and a review confidential proposals task 612.

As described hereinabove, each of the tasks 602-616 may be annotated in a manner that assists with analysis for determining whether one or more of the tasks 602-616 may be crowdsourced. For example, one or more of the tasks 602-616 may be annotated with an annotation specifying resource requirements of the task, confidentiality requirements of the task, a cost of having the task performed, task-task dependencies, etc.

More specifically, the advertise call for proposal task 604 may be annotated in a manner that indicates the advertise call for proposal task 604 will be performed many times. Further, the advertise call for proposal task 604 may be annotated with a proportional cost, to assist in determining the net cost benefit of crowdsourcing the multiple instances of the advertise call for proposal task 604. Accordingly, the crowdsourceability score of the advertise call for proposal task 604 may reflect the cost benefit, if any, of having the advertise call for proposal task 604 performed many times by crowdworkers.

Still yet, the review proposals task 608, without any decomposition, may be annotated such that it has a crowdsourceability score indicating that the review proposals task 608 is not permitted for crowdsourcing. However, when the review proposals task 608 is decomposed into the review non-confidential proposals task 610 and the review confidential proposals task 612, then the review non-confidential proposals task 610 is annotated such that it has a crowdsourceability score indicating that the review non-confidential proposals task 610 is a good candidate for crowdsourcing. For example, the crowdsourceability score of the review non-confidential proposals task 610 may exceed a pre-established threshold, and, based on this crowdsourceability score, the review non-confidential proposals task 610 may be selected for crowdsourcing in an alternative configuration of the workflow 600. Conversely, the review confidential proposals task 612 is annotated to reflect that it is not a good candidate for crowdsourcing. For example, the crowdsourceability score of the review confidential proposals task 612 may fail to exceed the pre-established threshold, and, based on this crowdsourceability score, the review confidential proposals task 612 may not be selected for crowdsourcing in an alternative configuration of the workflow 600.

In this manner, various tasks of a workflow may be annotated. Further, the annotations of the tasks may be subsequently analyzed to determine which tasks of the workflow should be provided to a crowdsourcing platform for completion by workers of the crowdsourcing platform.

Utilizing the systems and methods described herein, for a given workflow containing a plurality of tasks, predictions may be made regarding costs, in terms of time and resource utilization, of partially or completely executing the tasks on a crowdsourcing platform. Further, by migrating the tasks of workflows to crowdsourcing platforms without hiring experts or designating employees to manually review every entry (i.e., tasks, dependencies, resources, and entities), significant cost overhead may be avoided. The time previously spent by in-house employees determining which tasks should be crowdsourced may now instead be used to execute the tasks being kept in-house. One exemplary application of the methods and systems described herein includes the realm of software testing, where the use of a number of workers with different backgrounds may result in a significant increase in work quality at a reduced cost.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer-implemented method, comprising:
receiving a workflow, the workflow including a plurality of tasks;
for each of the tasks in the workflow, annotating the task with a set of metadata;
analyzing the tasks in the workflow utilizing the metadata annotations and one or more predefined policies; and
based on the analysis of the tasks, generating an alternative configuration of the workflow, the alternative configuration of the workflow being marked for crowdsourcing.

2. The computer-implemented method of claim 1, wherein the alternative configuration of the workflow includes at least one of the tasks in the received workflow for sharing with a crowdsourcing platform.

3. The computer-implemented method of claim 2, wherein the alternative configuration of the workflow includes all of the tasks in the received workflow for sharing with the crowdsourcing platform.

4. The computer-implemented method of claim 1, wherein, for each of the tasks in the workflow, the metadata annotation of the task includes at least one input annotation and at least one output annotation, wherein the at least one input annotation of the task includes one or more annotations selected from a group consisting of: a policy constraint of the task, a temporal constraint of the task, a structural constraint of the task, and a resource requirement of the task.

5. The computer-implemented method of claim 1, wherein analyzing the tasks in the workflow includes generating a crowdsourceability score for each task in the workflow.

6. The computer-implemented method of claim 5, wherein the crowdsourceability score for each task in the workflow is created based on one or more inputs selected from a group consisting of: natural language processing results, conceptual similarity metrics, dependencies between tasks, task-resource associations, and task-person associations.

7. The computer-implemented method of claim 5, wherein the alternative configuration of the workflow is created based at least in part on the crowdsourceability scores of the tasks.

8. The computer-implemented method of claim 1, wherein analyzing the tasks in the workflow includes natural language processing.

9. The computer-implemented method of claim 1, wherein analyzing the tasks in the workflow includes calculating conceptual similarity metrics.

10. A computer program product for migrating a workflow for processing on a crowdsourcing platform, the computer program product comprising a computer readable storage medium having program instructions embodied therewith, the program instructions executable by a processor to cause the processor to:
receive, by the processor, a workflow, the workflow including a plurality of tasks;
for each of the tasks in the workflow, annotate, by the processor, the task with a set of metadata;
analyze, by the processor, the tasks in the workflow utilizing the metadata annotations and one or more predefined policies; and
based on the analysis of the tasks, generate, by the processor, an alternative configuration of the workflow, the alternative configuration of the workflow being marked for crowdsourcing.

11. The computer program product of claim 10, wherein the alternative configuration of the workflow includes at least one of the tasks in the received workflow for sharing with a crowdsourcing platform.

12. The computer program product of claim 10, wherein, for each of the tasks in the workflow, the metadata annotation of the task includes at least one input annotation and at least one output annotation, wherein the at least one input annotation of the task includes one or more annotations selected from a group consisting of: a policy constraint of the task, a temporal constraint of the task, a structural constraint of the task, and a resource requirement of the task.

13. The computer program product of claim 10, wherein analyzing the tasks in the workflow includes generating a crowdsourceability score for each task in the workflow.

14. The computer program product of claim 13, wherein the crowdsourceability score for each task in the workflow is created based on one or more inputs selected from a group consisting of: natural language processing results, conceptual similarity metrics, dependencies between tasks, task-resource associations, and task-person associations.

15. The computer program product of claim 13, wherein the alternative configuration of the workflow is created based at least in part on the crowdsourceability scores of the tasks.

16. The computer program product of claim 10, wherein analyzing the tasks in the workflow includes natural language processing.

17. The computer program product of claim 10, wherein analyzing the tasks in the workflow includes calculating conceptual similarity metrics.

18. A system, comprising:
a processor and logic integrated with and/or executable by the processor, the logic being configured to:
receive a workflow, the workflow including a plurality of tasks;
for each of the tasks in the workflow, annotate the task with a set of metadata;
analyze the tasks in the workflow utilizing the metadata annotations and one or more predefined policies including generating a crowdsourceability score for each task in the workflow; and
based on the analysis of the tasks and the crowdsourceability scores, generate an alternative configuration of the workflow, the alternative configuration of the workflow being marked for crowdsourcing.

19. The system of claim 18, wherein the alternative configuration of the workflow includes at least one of the tasks in the received workflow that have been selected for sharing with a crowdsourcing platform.

20. The system of claim 18, wherein the crowdsourceability score for each task in the workflow is created based on one or more inputs selected from a group consisting of: natural language processing results, conceptual similarity metrics, dependencies between tasks, task-resource associations, and task-person associations.
